(19) United States
(12) Patent Application Publication
(10) Pub. No.: US 2026/0368802 A1
(43) Pub. Date: Nov. 19, 2026

(54) SYSTEMS AND METHODS FOR CONTROLLING EVENT TICKETS

(71) Applicant: SEATGEEK, INC., New York, NY (US)

(72) Inventors: Stephen Donald D'AMICO, New York, NY (US); Victoria Margarite UGARTE, New York, NY (US); Roman BELOPOLSKY, New York, NY (US); Eric RJ WALLER, New York, NY (US); Jason Peter HERSKOWITZ, New York, NY (US); Phillip Shi-Jeh TANG, New York, NY (US); Heidi Elizabeth AUSTIN, Milford, MA (US); Peter James MAGENHEIMER, Berlin (DE)

(21) Appl. No.: 19/751,374

(22) Filed: Jul. 23, 2026

Related U.S. Application Data
(63) Continuation of application No. 18/999,323, filed on Dec. 23, 2024.
(60) Provisional application No. 63/614,539, filed on Dec. 23, 2023.

(51) Int. Cl. G06Q 30/0601; G06F 21/10; G06Q 10/02; G06Q 40/04

(52) U.S. Cl. CPC G06Q 30/0641; G06F 21/1015; G06Q 10/02; G06Q 40/04

(57) ABSTRACT

Systems and methods for purchasing event tickets enable a first individual to purchase a ticket to an event at an event venue. The first individual can thereafter transfer limited rights to use the purchased ticket to a second individual. The first individual can also later revoke the limited use rights to the purchased ticket and re-assign the limited use rights to a third individual.

### CROSS-REFERENCE TO RELATED APPLICATION

This application is a continuation of U.S. Application No. 18/999,323, which was filed on Dec. 23, 2024, which itself claims priority to the Dec. 23, 2023 filing date of U.S. Provisional Patent Application No. 63/614,539. The contents of both applications are incorporated herein by reference.

### BACKGROUND OF THE INVENTION

The invention is related to the way in which tickets to events are issued and controlled. In particular, the invention relates to how electronically issued event tickets can be purchased and shared, and how the purchaser can exert control over how shared tickets are used.

Before the issuance of electronic event tickets became prevalent, event tickets were typically printed. The printed tickets could include various anti-counterfeiting devices to help ensure that a printed ticket was valid and could not be improperly duplicated. Once printed and delivered to a purchaser, a printed ticket could be readily shared, given or sold to a third party. A third party receiving a printed ticket from the ticket’s initial purchaser could then use the printed ticket to gain entrance to the event for which the ticket was issued. The third party could also pass the printed ticket along to yet another third party, who could then use the printed ticket to gain entrance to the event.

Essentially, a printed ticket could be used by whoever had physical possession of the printed ticket. This characteristic of a printed ticket has advantages and drawbacks. One advantage is that it is relatively easy to transfer possession of a valid ticket from one party to another, whether that be via a gift or a sale. Of course, this also means that once the purchaser of a printed ticket hands the printed ticket off to another person, the original purchaser can no longer control who ultimately uses the ticket to gain entrance to the event. Any person who ends up possessing the printed ticket can use the ticket to gain entrance to the event.

Many event tickets are now issued electronically. Electronically issued event tickets can then be printed, and the printed version of the electronic ticket can often be used in exactly the same way as a traditional printed ticket. This means whoever possesses the printed version of an electronically issued ticket can use the printed version of the electronically issued ticket to gain access to the event for which the ticket was issued.

An electronically issued ticket often can be used in its electronic form to gain access to an event for which the ticket was issued. Typically, this involves storing ticketing data that can be used to electronically render a ticket including a machine-readable code that encodes the ticketing data. That electronically issued ticket can be displayed on a mobile computing device, such as a smartphone. When the user who possesses the electronically issued ticket arrives at the event venue, the user uses ticketing software to render the electronically issued ticket on the display of their mobile computing device. A person controlling entry to the event scans the machine-readable portion of the ticket with a portable scanning device, and the information contained in the machine-readable portion of the ticket is compared to corresponding validation information in a central database. If the information read from the machine-readable portion of the ticket is verified, the user is allowed entry to the event.

It may also be possible for a user to capture a screenshot of a rendered electronically issued ticket. The user could then call up the screenshot of the ticket to gain entrance to the event venue.

Regardless of how a user obtains an image of an electronically issued ticket, the purchaser of an electronically issued event ticket may be able to forward the image of the electronically issued ticket on to another user via a computer network. For example, the purchaser of an electronically issued event ticket could forward an image of the electronically issued ticket to a third party as an attachment to an email or perhaps via a text messaging software application. This makes it easy to share and sell electronically issued event tickets. However, this also means that once the purchaser of an electronically issued event ticket has transferred the image of the event ticket to another party, the original purchaser can no longer control who uses the image of the electronically issued event ticket to gain entrance to the event.

There are various ways of preventing a mere image of an electronically issued ticket from being improperly used. One common way is for the software that renders an image of an electronically issued ticket to vary the machine-readable portion of the ticket image on a periodic basis so that an image of a rendered electronic ticket that was rendered an hour ago will no longer be deemed valid when checked at the entrance to the venue.

### BRIEF DESCRIPTION OF THE DRAWINGS

FIG. 1 is a diagram of an environment in which event tickets can be purchased and shared between users;

FIG. 2 is a diagram of a ticketing software application that can be used to purchase and share event tickets;

FIG. 3 is a diagram illustrating selected elements of a ticket service provider;

FIG. 4 is a flow diagram illustrating steps of a method of granting rights to use an event ticket to an offered party;

FIG. 5 is a flow diagram illustrating steps of a method of revoking an offered party’s right to use an even ticket; and

FIG. 6 is a diagram of elements of a computing device that could be used to practice the invention.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

The invention relates to systems and methods that allow a first user who purchases event tickets to exert some degree of control over who uses one of the purchased event tickets. For example, assume a user purchases a block of four tickets to an event, for four adjacent seats in the event venue. With the systems and methods disclosed herein the purchaser could electronically offer three of the four event tickets to three other users, respectively. Each of the three other users would then utilize a software program to electronically claim the ticket offered by the purchaser. Once a user has electronically claimed a ticket from the ticket purchaser, the user can utilize the claimed electronic ticket to gain entrance to the event. However, each of the three users who claim a ticket offered by the ticket purchaser would be prevented from transferring or offering their ticket to another user. Instead, each of the tickets that were electronically claimed from the ticket purchaser could only be used by the party to whom the ticket purchaser initially offered the event ticket. Moreover, the original purchaser would have the ability to electronically reclaim any of the tickets offered to other users, and to then electronically offer the reclaimed ticket to a different party.

Note, with the disclosed systems and methods it is still possible for a ticket purchaser to electronically transfer or sell an electronically purchased ticket to another party. If a ticket is transferred to another party, the receiving party will have complete control over the ticket and the original purchaser will no longer be able to exert any control over how the ticket is used. However, with the disclosed systems and methods it is possible for a ticket purchaser electronically send an electronic ticket to another party and for the other party to use that electronic ticket, while at the same time stopping short of transferring all control over the event ticket to the other party. Instead, the disclosed systems and methods make it possible for the ticket purchaser to electronically send an event ticket to another party for that party’s use while the ticket purchaser retains the ability to recall the electronic ticket and send it to a different party.

For purposes of this description we will make a distinction between “transferring” a ticket and “offering” a ticket. If a ticket purchaser “transfers” a ticket to a receiving party (which can include a sale), the receiving party gains complete control over the ticket and the purchaser no longer controls how the ticket is used. If a ticket purchaser “offers” a ticket to a receiving party, and the receiving party “claims” the offered ticket, then the ticket purchaser retains control over how the ticket is used. In the second case, only the party claiming the ticket can use the ticket to gain entrance to the event. Also, the ticket purchaser retains the ability to reclaim the ticket and to use the reclaimed ticket himself or offer or transfer the ticket to another party.

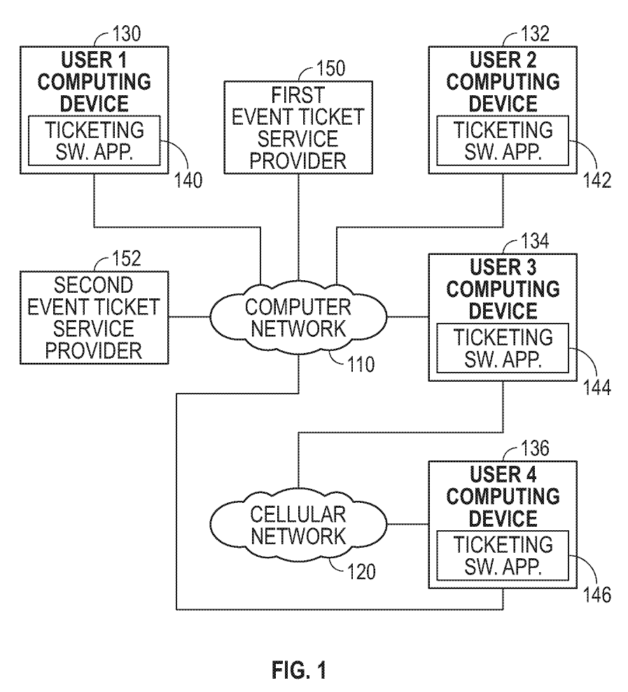

FIG. 1 illustrates an environment in which the invention can be practiced. This environment includes user computing devices 130, 132, 134, 136. The user computing devices could be traditional personal computers, laptop computers, other portable computing devices like the Apple iPad and other similar tablet devices, as well as smartphones. Virtually any fixed, mobile or portable computing device capable of running a ticketing software application could be part of the communications environment. Although FIG. 1 shows only four computing devices, in a real-world implementation, a much larger number of computing devices would likely be a part of such an environment.

A ticketing software application 140, 142, 144, 146 is loaded onto each of the respective computing devices 130, 132, 134, 136. The functionality of the ticketing software application is discussed in greater detail below.

A first event ticket service provider 150 and a second event ticket service provider 152 are present in the environment. A user could electronically purchase event tickets to various events from the first and second event ticket service providers 150, 152. A user could utilize the ticketing software application on the user’s computing device to interact with an event ticket service provider to make such ticket purchases. Alternatively, a web browser software application on the user’s computing device could be used to access a website run by one of the event ticket service providers 150, 152 to purchase event tickets. Although FIG. 1 shows only two event ticket service providers 150, 152, in a real-world implementation a much larger number of event ticket service providers would likely be a part of such an environment.

The computing devices 130, 132, 134, 136 are capable of communicating with each other and with the first and second event ticket service providers 150, 152 via a computer network 110 and/or a cellular network 120. The computer network 110 could include private computer networks and public networks such as the Internet. The cellular network 120 would allow mobile computing devices such as smartphones to communicate via radio links to nearby cellular base stations. In each case, digital data communications would be exchanged between the computing devices themselves 130, 132, 134 and 136 and between the computing devices and the first and second event ticket service providers 150, 152 via the computer network 110 and/or the cellular network 120.

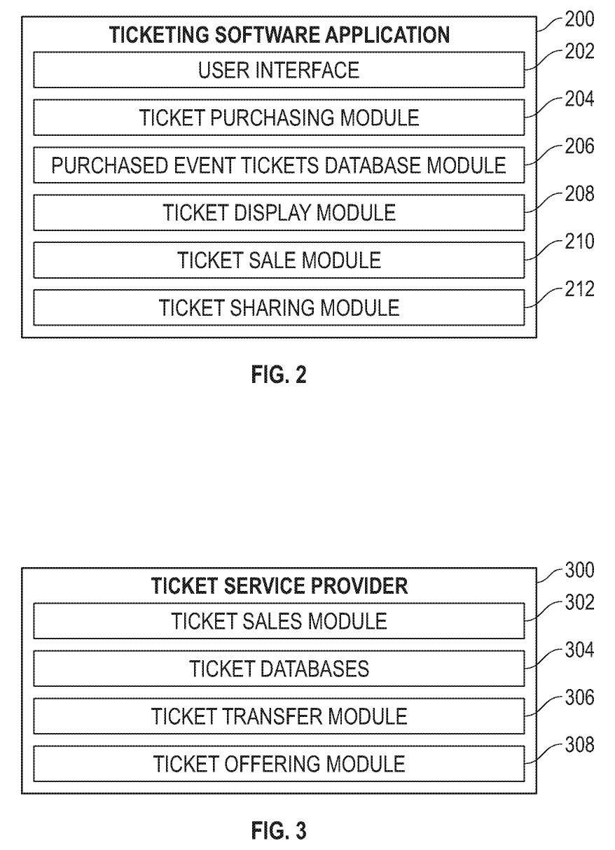

FIG. 2 illustrates some elements of a ticketing software application 200, which could be one of the ticketing software applications 140, 142, 144 and 146 illustrated in FIG. 1. The ticketing software application 200 includes a user interface 202 that enables the user to interact with other elements of the ticketing software application 200 and with event ticket service providers. The software application 200 also includes a ticket purchasing module 204 that enables a user to purchase event tickets from one or more event ticket service providers. The ticket purchasing module could include functionality to give a user the ability to search for upcoming events, to search for available tickets at upcoming events and make the financial transactions necessary to purchase event tickets.

The software application 200 itself may include a purchased event tickets database module 206 which stores and/or retrieves information about event tickets that the user has purchased. The purchased event tickets database module 206 could include the databases themselves, or such databases could be remote cloud-based databases that are maintained by a provider of the ticketing software application 200 or by one or more of the event ticket service providers 150, 152. When the purchased ticket databases are remote databases, the purchased event tickets database module 206 would act as an interface to access the remotely stored data about purchased tickets. This could include information that could be used to generate images of event tickets, including barcodes and encoded time-based passwords.

The software application 200 also includes a ticket display module 208 which is capable of displaying an event ticket, including machine-readable information that can be scanned at an event venue entrance to gain access to an event. The ticket display module 208 may interact with the purchased event ticket database module 206 to retrieve information about purchased tickets, offered and claimed tickets and transferred tickets so that those tickets can be displayed.

In some embodiments, the software application 200 may include a purchased ticket sale module 210 which enables a user who has purchased an event ticket to sell the event ticket to a third party, or to one of the event ticket service providers 150, 152. The purchased ticket sale module 210 may include the functionality to transfer money or credits to a bank account or a credit or debit card account to make it possible for the user to receive money in exchange for the sale of a ticket.

The software application 200 includes a ticket sharing module 212 which enables a user who has purchased event tickets to offer those tickets to other users, while still retaining some degree of control over how the offered event tickets are used.

While the depiction in FIG. 2 and the foregoing description disclose some typical elements that may be present in a ticketing software application embodying the invention, other features and modules may also be present in some embodiments. Likewise, some embodiments of the invention may not include all of the features illustrated in FIG. 2 and discussed above. Thus, FIG. 2 and the foregoing description should in no way be considered limiting.

FIG. 3 illustrates selected elements of a ticket service provider 300. The ticket service provider 300 may be the entity that provides the software application 200 discussed above to users.

The ticket service provider 300 includes a ticket sales module 302 that allows users to purchase event tickets. The ticket sales module 302 could interact with users via the ticket purchasing module 204 of the user’s ticketing software application 200. Alternatively, the ticket sales module could interact with users via a web or Internet interface. Typically the users of the ticket service provider 300 would be registered with the ticket service provider 300. As a result, when a user purchases one or more tickets the tickets would be recorded as being owned by the user. The user could then access those tickets for purposes of offering one or more purchased tickets to another user or for resale/transfer via a web or Internet interface, or via the ticketing software application 200.

The ticket service provider 300 also includes ticket databases 304 that include information about each of the tickets controlled, sold or purchased by the ticket service provider 300. The purchased event tickets database module 206 of a user’s ticketing software application 200 would interact with these ticket databases 304 to obtain information about purchased, shared or transferred tickets.

The ticket service provider also includes a ticket transfer module 306 that can be used to transfer ownership of one or more event tickets from a first party to a second party. The ticket transfer module could interact with the ticket sale module 210 of a user’s ticketing software application 200. When the owner of an event ticket sells, gives or otherwise transfers ownership and control of an event ticket to a purchaser, the ticket transfer modules make adjustments to the information about that event ticket that is stored in the ticket databases 304, as discussed below.

The ticket service provider further includes a ticket offering module 308 that can be used to grant a party the right or ability to use an event ticket. The ticket offering module 308 can also revoke or cancel a party’s ability to use an event ticket, as discussed below. The ticket offering module 308 may interact with a ticket sharing module 212 of a user’s ticketing software application 200 to grant and revoke the right or ability to use an event ticket to a particular party.

The ticket offering module 308 is configured to alter information in one or more ticket databases 304 to grant an offered party the ability to use an event ticket and to revoke or cancel an offered party’s ability to use an event ticket. This would be done by changing information in one or more fields of one or more records of a ticket database that relate to the event ticket.

Currently, ticket databases 304 have one or more fields in a record relating to an individual event ticket that is used to record information about the owner of the event ticket. In systems and methods as disclosed herein, the ticket databases 304 are revised to include one or more additional fields that contain information about the identity of a party who is authorized to use an event ticket. When the owner of a ticket offers use of the ticket to an offered party, and the offered party accepts, the ticket offering module 308 changes or adds information to the fields of one or more records relating to the ticket to reflect that the offered party is now authorized to use the ticket. If the owner of the ticket later revokes that party’s right to use the ticket, the ticket offering module 308 updates or changes the information in the fields of one or more ticket databases for the ticket to reflect that the original offered party is no longer authorized to use the ticket.

Systems and methods as described herein require that existing ticket databases be updated to include one or more additional fields that are used to contain information about one or more parties who are authorized to use a ticket, in addition to the existing fields that reflect ownership of the ticket. The added fields can contain information about the identity of the party or parties that are authorized to use a ticket. The added fields may also contain information about what sort of use privileges an authorized user has. For example, the use privileges could be use only, or use and the ability to grant another use of the ticket, or use and the ability to sell the ticket. All of these additional database fields and the information contained therein would need to be added to existing ticket databases 304 in order to implement the disclosed methods.

The ticket service provider 300 could be one of the event ticket service providers 150, 152 illustrated in FIG. 1. A ticket service provider 300 would likely include far more things than the ticket sales module 302 and ticket databases 304 illustrated in FIG. 3. Thus, the depiction in FIG. 3 and the foregoing description should in no way be considered limiting.

Before discussing the advantages of the disclosed systems and methods, it is helpful to first review what happens when tickets are purchased and shared.

In presently existing systems, when the ticket sales module 302 of a ticketing service provider 300 sells a ticket to a user, information about the ticket and the sale is recorded in the ticket databases 304. The information recorded in the ticket databases 304 may include, without limitation, a ticket number, ticket metadata such as the event information and a row and seat number, a ticket version number, and the current owner. In addition, a barcode (or information used to generate a barcode) for the ticket is generated and saved in the ticket databases 304.

The current owner recorded in the ticket databases for a ticket would originally be the party to whom the ticket was sold. If ownership of a ticket is transferred to a third party, the current owner information in the ticket databases 304 would be updated to identify the third party to whom the ticket was transferred. When a ticket is sold, given or otherwise transferred from a first party to a second party, the ownership information in the ticket databases 304 would be changed. In addition, new barcode information for the ticket may be generated and saved in the ticket databases 304. When new barcode information is generated for a ticket, the ticket number or version number of the ticket may also be updated and saved in the ticket databases 304.

When the owner of a ticket wishes to use the ticket to gain entrance to the event, the owner typically uses the ticketing software application 200 on the owner’s mobile device, such as a smartphone, to render an image of the ticket on a display screen of the user’s mobile computing device. This means the ticket display module 208 of the ticketing software application 200 obtains information about the ticket, to include the current barcode information for the ticket, and generates a display of this information on the owner’s mobile computing device. This can include the ticket display module 208 obtaining the necessary information from the purchased event ticket database module 206, or the ticket display module 208 obtaining the necessary information from the ticket databases 304 via the purchased event tickets database module 206. Also, a time-based password or barcode could be generated by the ticket display module 208 and displayed along with the other ticketing data.

An individual controlling access to the event then uses a scanner to read machine-readable code from the information displayed on the user’s mobile computing device. That information is verified. If the displayed information is valid, the user is allowed access to the event venue.

When a first user buys a block of tickets, that first user can then offer tickets in the block that the user himself will not use to other parties. Under existing systems, when a ticket is transferred from a first user to a second user, the transfer is treated in essentially the same way as a sale, although no money or other goods may be exchanged in connection with the transfer. A new barcode is generated and saved in the ticket databases 304, the ticket version is incremented and the second user is recorded as new owner of the ticket in the ticket databases 304.

The existing way of transferring a ticket to a third party caused various problems. First, it allowed the second user that received a transferred ticket to then transfer the ticket along to a third user, which might go against the wishes of the original owner of the ticket. It also made it impossible for the first user to pull the ticket back and pass it along to a third user, which might be desirable if the second user became unable or unwilling to attend the event. Instead, it would be necessary for the second user, who is recorded as the new owner, to transfer the ticket to a third user.

Also, there are instances where an owner of a ticket ends up transferring a ticket to a wrong, unintended party. Once the transfer is made, the original ticket owner has no way to reclaim the ticket and transfer it to the correct party.

Because of the problems associated with giving up control upon transfer or sale, it is common for a user who purchases a block of tickets to retain ownership and control of the entire block of tickets. But this creates its own set of issues and potential problems.

If one of a group of people that is planning to attend the event arrives before the individual that purchased the block of tickets, it will be impossible for that person to gain entry to the event. Instead, the individual who has ownership of all the tickets will need to arrive and cause his mobile computing device to display all the tickets so that all the members of the group can gain access to the event. This problem can become acute if the individual who purchased and owns the block of tickets is late and the event is about to start.

The present application discloses a modified way of sharing a ticket with another user that avoids the problems noted above. In the disclosed systems and methods, the owner of a ticket can use the ticket sharing module 212 of the owner’s ticketing software application 200 to offer use of the ticket to a second user such that the second user can only display the ticket to gain entry to the event. Assuming the second user claims the offered ticket, a new barcode is issued for the ticket and recorded in the ticket databases 304. The version number of the ticket is also incremented to reflect that a new barcode was issued. The ownership information in the ticket databases 304 is not changed. However, information in the ticket databases 304 is updated to reflect that the second user has “display-only” or use rights.

If the second user who claims an offered ticket wishes to use the ticket to gain entry to the event venue, the second user can still use the ticket display module 208 of their ticketing software application 200 on their mobile computing device to display the ticket and gain entry to the venue. The fact that the second user has been granted display-only or use rights in the ticket databases 304 makes this possible, even though the ticket databases 304 also indicate that the first user still owns the ticket.

The first user, the owner of the ticket, has the ability to reclaim the offered ticket and to then offer use of the reclaimed ticket to a third user. If the first user reclaims a ticket and offers the ticket to a third user, and the third user claims the offered ticket, the system again issues a new barcode, increments the version number of the ticket to reflect that a new barcode was issued and adjusts the information in the ticket databases 304 to indicate that the third user now has display-only or use rights.

In some embodiments, in order for a first user to offer a purchased ticket to a second user, both the first user and the second user must be users of the same ticket service provider and must be running an instantiation of the same ticketing software application 200, as depicted in FIG. 2. However, it would be possible for two or more ticket service providers to cooperate in such a way that users of a first ticket service provider could offer use of tickets to users of a second ticket service provider. Thus, it is not necessary for all users to be using the same software application in order for a ticket owner using a first type of ticketing software to offer use of a ticket to a user running a second different type of ticketing software.

With the novel ticket sharing method described above, a user who claims an offered ticket owned by another is not able to use the ticket in a way that is contrary to the purchasing user’s wishes.

In some embodiments, it is possible for a ticket owner to specify the ways in which a shared or offered ticket can be used. For example, the owner could specify that a second user can only use an offered ticket themselves to gain entry to the event venue. Or the owner could specify that the second user is only able to offer the ticket to a specific group of other users. In another instance the ticket owner could specify that the second user could offer the ticket along to another user, but not receive money in exchange for the ticket. In still other instances, the ticket owner could specify that the second user can utilize the offered ticket in any way they wish, including selling or transferring the ticket to a third party.

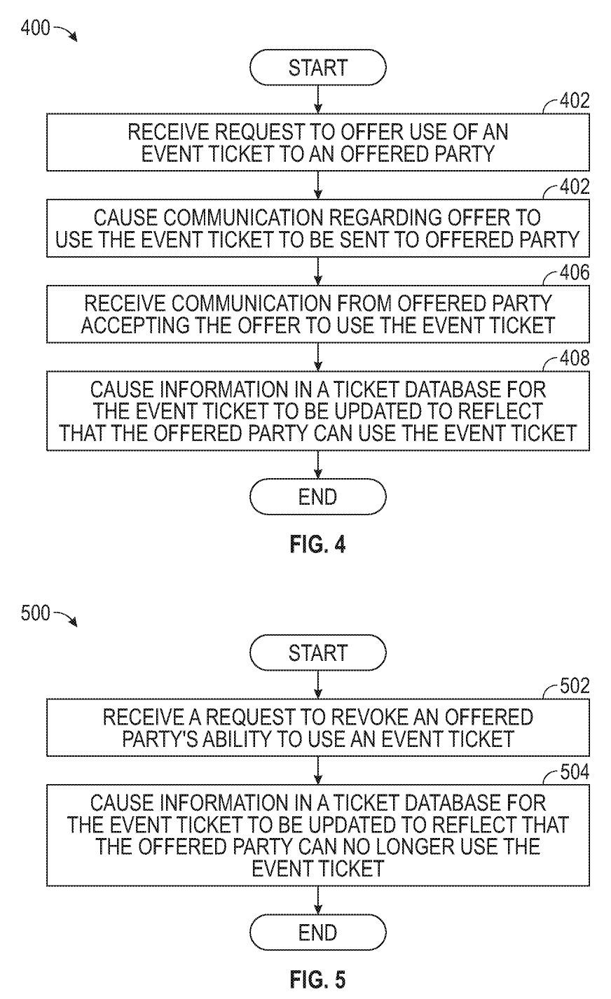

FIG. 4 illustrates steps of a method 400 in which the owner of an event ticket grants the right to use the event ticket to an offered party. The steps of this method would be performed by elements of a ticket service provider 300, like the one illustrated in FIG. 3. However, in doing so the elements of the ticket service provider 300 may interact with one or more elements of a user’s ticketing software application, including the ticket owner’s ticketing software application and the offered party’s ticketing software application.

The method 400 begins and proceeds to step 402, in which a request to offer use of an event ticket to an offered party is received from the ticket owner. The received request would include an identification of the ticket that is to be offered, as well as information identifying the offered party to which use of the ticket is being offered. This step 402 can involve the ticket offering module 308 receiving such a request from the ticket owner in any one of multiple different ways. In some instances, the ticket owner may use the ticket sharing module 212 of the owner’s ticketing software application to send the request to offer the ticket to the offered party. In other instances, the ticket owner may interact with a website provided by the ticket service provider 300 to send the request to the ticketing offering module 308. In still other instances, the ticket owner may send an electronic communication to the ticket offering module 308 to request that use of the ticket be offered to the offered party. Such an electronic communication could be an email message, a text message or some other form of electronic communication.

Next, in step 404, the ticket offering module 308 of the ticket service provider 300 causes a communication regarding the offer to use the event ticket to be sent to the offered party. The ticket offering module 308 could cause this communication to be sent to the offered party in any of multiple different ways. In some instances, the ticket offering module may cause a communication about the offer to be presented to the offered party via the ticket sharing module 212 of the offered party’s ticketing software application 200. In other instances, the ticket offering module 308 could cause an electronic communication regarding the offer to use the event ticket to be sent to the offered party. Such an electronic communication could be in the form of an email message, a text message or some other type of electronic communication.

In step 406, the ticket offering module 308 receives a response from the offered party in which the offered party accepts the offer to use the event ticket. The response received from the offered party could be received by the ticket offering module in any of multiple different ways. In some instances, the offered party could send the response via a ticket sharing module 212 of the offered party’s ticketing software application 200. In other instances, the response could be a response to an electronic communication that delivered the offer to the offered party. For example, if the offer was sent to the offered party via an email message, the response could be a responsive email message. If the offer was sent to the offered party via a text message, the response could be a responsive text message. In any event, the response would indicate that the offered party wishes to accept the offer to use the event ticket.

In step 408, the ticket offering module then updates information in one or more ticket databases 304 to reflect the fact that the offered party now has the right to use the event ticket. This can include updating the ticket databases 304 to indicate that the offered party now has display-only or use rights to the event ticket. This can also include causing new barcode information for the event ticket to be generated and stored in one or more ticket databases 304. Further, when new barcode information is generated, a ticket version number stored in one or more ticket databases 304 may be incremented to reflect that new barcode information has been created for the event ticket. The method then ends.

FIG. 5 illustrates steps of a method 500 for revoking an offered party’s right to use an event ticket. The steps of this method would be performed by one or more elements of a ticket service provider 300, like the one illustrated in FIG. 3. However, in doing so the elements of the ticket service provider 300 may interact with one or more elements of a user’s ticketing software application, including the ticket owner’s ticketing software application and the offered party’s ticketing software application.

The method 500 begins and proceeds to step 502, in which a request to revoke an offered party’s right or ability to use an event ticket is received from the ticket owner. The received request would include at least an identification of the event ticket. The request may also include information identifying the offered party. This step 502 can involve the ticket offering module 308 receiving such a request from the ticket owner in any one of multiple different ways. In some instances, the ticket owner may use the ticket sharing module 212 of the owner’s ticketing software application to send the request to the ticket offering module 308. In other instances, the ticket owner may interact with a website provided by the ticket service provider 300 to send the request to the ticketing offering module 308. In still other instances, the ticket owner may send such a request via an electronic communication that is directed to the ticket offering module 308. Such an electronic communication could be an email message, a text message or some other form of electronic communication.

In step 504, the ticket offering module 308 then acts to cause information in one or more ticket databases 304 to change to reflect the fact that the offered party can no longer make use of the event ticket. This can include adjusting one or more entries in one or more ticket databases 304 to indicate that the offered party no longer has display-only or use rights to the event ticket. This can also include causing new barcode information for the event ticket to be generated and stored in one or more ticket databases 304. Further, when new barcode information is generated, a ticket version number stored in one or more ticket databases 304 may be incremented to reflect that new barcode information has been created for the event ticket. The method 500 then ends.

The invention may be embodied in methods, apparatus, electronic devices, and/or computer program products. Accordingly, the invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

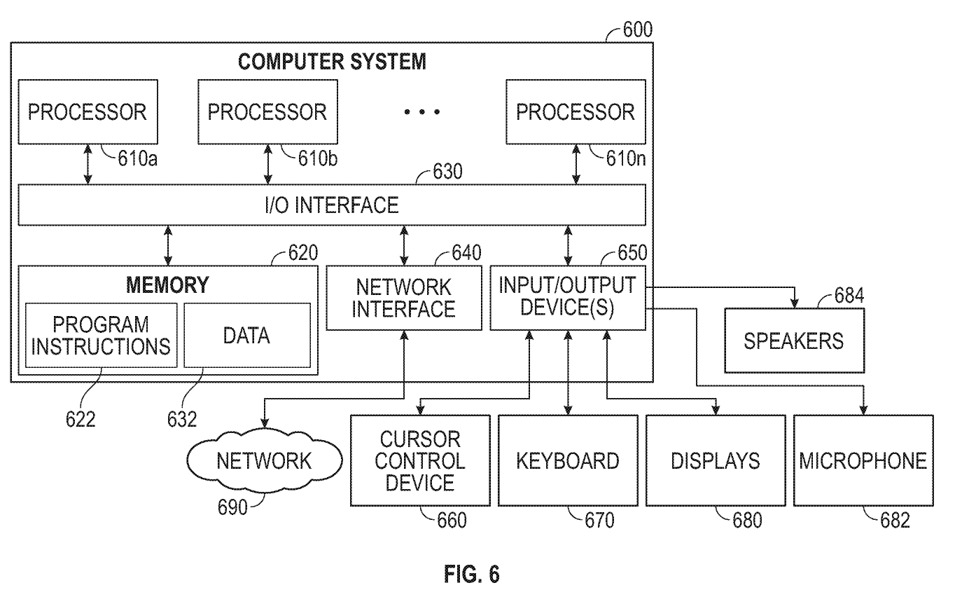

FIG. 6 depicts a computer system 600 that can be utilized in various embodiments of the present invention to implement the invention according to one or more embodiments. The various embodiments as described herein may be executed on one or more computer systems, which may interact with various other devices. One such computer system is the computer system 600 illustrated in FIG. 6. The computer system 600 may be configured to implement the methods described above. The computer system 600 may be used to implement any other system, device, element, functionality or method of the above-described embodiments. In the illustrated embodiments, the computer system 600 may be configured to implement the disclosed methods as processor-executable executable program instructions 622 (e.g., program instructions executable by processor(s) 610) in various embodiments.

In the illustrated embodiment, computer system 600 includes one or more processors 610a-610n coupled to a system memory 620 via an input/output (I/O) interface 630. Computer system 600 further includes a network interface 640 coupled to I/O interface 630, an input/output devices interface 650. The input/output devices interface 650 facilitates connection of external I/O devices to the system 600, such as cursor control device 660, keyboard 670, display(s) 680, microphone 682 and speakers 684. In various embodiments, any of the components may be utilized by the system to receive user input described above. In various embodiments, a user interface may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, the computer system 600 may be any of various types of devices, including, but not limited to, a personal computer system, desktop computer, laptop, notebook, or netbook computer, a portable computing device, a mainframe computer system, handheld computer, workstation, network computer, a smartphone, a camera, a set top box, a mobile device, a consumer device, video game console, handheld video game device, application server, storage device, a peripheral device such as a switch, modem, router, or in general any type of computing or electronic device.

In various embodiments, the computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices interface 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

External input/output devices interface 650 may, in some embodiments, include one or more display terminals, keyboards, keypads, touchpads, scanning devices, voice or optical recognition devices, or any other devices suitable for entering or accessing data by one or more computer systems 600. Multiple input/output devices may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the operations and methods described above, such as the methods illustrated by the flowcharts of FIGS. 3-5. In other embodiments, different elements and data may be included.

Those skilled in the art will appreciate that the computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

In many of the foregoing descriptions, a software application running on a telephony device may perform certain functions related to the disclosed technology. In alternate embodiments, a browser running on the telephony device may access a software application that is running on some other device via a data network connection. For example, the software application could be running on a remote server that is accessible via a data network connection. The software application running elsewhere, and accessible via a browser on the telephony device may provide all of the same functionality as an application running on the telephony device itself. Thus, any references in the foregoing description and the following claims to an application running on a telephony device are intended to also encompass embodiments and implementations where a browser running on a telephony device accesses a software application running elsewhere via a data network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A non-transitory computer readable medium bearing instructions which, when run by one or more processors of a computing device cause the computing device to perform a method of purchasing ticket rights, the method comprising:
receiving instructions from a first individual regarding the purchase of a ticket for a seat at an event in an event venue;
interacting with a ticket seller or reseller to purchase the ticket identified in the received instructions.

2. The non-transitory computer readable medium of claim 1, wherein interacting with the ticket seller or reseller also results in a record in a database of ticket information that corresponds to the purchased ticket being updated to reflect that the first individual is the owner of purchased ticket, and wherein interacting with the ticket seller or reseller also results in first barcode information being recorded in the record in the ticket database that corresponds to the purchased ticket, where the first barcode information can be acquired and used by the first individual to cause a barcode to be displayed on a display screen to enable the first individual to gain access to the event at the event venue.

3. The non-transitory computer readable medium of claim 2, wherein the method performed by the one or more processors also comprises:
receiving instructions from the first individual indicating that limited use rights to the purchased ticket are to be offered to a second individual, the limited use rights allowing the second individual to access the event at the event venue; and
causing an offer of the limited use rights to the purchased ticket to be communicated to the second individual, wherein if the second individual accepts the limited use rights, information in the record of the database of ticket information corresponding to the purchased ticket is updated to reflect that the second individual has limited use rights to the purchased ticket and the first barcode information recorded in the record of the ticket database corresponding to the purchased ticket is replaced with second barcode information, where the second barcode information can be acquired and used by the second individual to cause a barcode to be displayed on a display screen to enable the second individual to gain access to the event at the event venue if the limited use rights to the purchased ticket are not subsequently revoked by the first individual.

4. The non-transitory computer readable medium of claim 3, wherein the limited use rights are display-only rights that enable the second individual to acquire and use the second barcode information to cause a barcode to be displayed on a display screen to enable the second individual gain access to the event at the event venue but which do not enable the second individual to transfer any use rights to the purchased ticket to a third party.

5. The non-transitory computer readable medium of claim 3, wherein the limited use rights include display rights that enable the second individual to acquire and use the second barcode information to cause a barcode to be displayed on a display screen to enable the second individual to gain access to the event at the event venue and that enable the second individual to transfer limited use rights to the purchased ticket to a third party.

6. The non-transitory computer readable medium of claim 3, wherein the method performed by the one or more processors further comprises:
receiving instructions from the first individual indicating that the limited use rights to the purchased ticket are to be transferred to a third individual; and
causing an offer of the limited use rights to the purchased ticket to be communicated to the third individual, wherein if the third individual accepts the limited use rights, information in the record of the database of ticket information corresponding to the purchased ticket is updated to reflect that the third individual has limited use rights to the purchased ticket and the second barcode information recorded in the record of the ticket database corresponding to the purchased ticket is replaced with third barcode information, where the third barcode information can be acquired and used by the third individual to display a barcode that enables the third individual to gain access to the event at the event venue if the limited use rights to the purchased ticket are not subsequently revoked by the first individual.

7. The non-transitory computer readable medium of claim 3, wherein the method performed by the one or more processors further comprises:
receiving instructions from the first individual indicating that the limited use rights to the purchased ticket previously granted to the second individual are to be revoked;
causing information in the record of the database of ticket information corresponding to the purchased ticket to be updated to reflect that the first individual again has all rights to the purchased ticket; and
causing the second barcode information recorded in the record of the ticket database corresponding to the purchased ticket to be replaced with third barcode information, where the third barcode information can be acquired and used by the first individual to cause a barcode to be displayed on a display screen to enable the first individual to gain access to the event at the event venue.

8. A system configured to purchase ticket rights, the system comprising:
a memory; and
one or more processors that are configured to perform a method comprising the steps of:
receiving instructions from a first individual regarding the purchase of a ticket for a seat at an event in an event venue;
interacting with a ticket seller or reseller to purchase the ticket identified in the received instructions.

9. The system of claim 8, wherein interacting with the ticket seller or reseller results in a record in a database of ticket information that corresponds to the purchased ticket being updated to reflect that the first individual is the owner of purchased ticket, and wherein interacting with the ticket seller or reseller also results in first barcode information being recorded in the record in the ticket database that corresponds to the purchased ticket, where the first barcode information can be acquired and used by the first individual to cause a barcode to be displayed on a display screen to enable the first individual to gain access to the event at the event venue.

10. The system of claim 9, wherein the method performed by the one or more processors further comprises:
receiving instructions from the first individual indicating that limited use rights to the purchased ticket are to be offered to a second individual, the limited use rights allowing the second individual to access the event at the event venue; and
causing an offer of the limited use rights to the purchased ticket to be communicated to the second individual, wherein if the second individual accepts the limited use rights, information in the record of the database of ticket information corresponding to the purchased ticket is updated to reflect that the second individual has limited use rights to the purchased ticket and the first barcode information recorded in the record of the ticket database corresponding to the purchased ticket is replaced with second barcode information, where the second barcode information can be acquired and used by the second individual to cause a barcode to be displayed on a display screen to enable the second individual to gain access to the event at the event venue if the limited use rights to the purchased ticket are not subsequently revoked by the first individual.

11. The system of claim 10, wherein the limited use rights are display-only rights that enable the second individual to acquire and use the second barcode information to cause a barcode to be displayed on a display screen to enable the second individual gain access to the event at the event venue but which do not enable the second individual to transfer any use rights to the purchased ticket to a third party.

12. The system of claim 10, wherein the limited use rights include display rights that enable the second individual to acquire and use the second barcode information to cause a barcode to be displayed on a display screen to enable the second individual to gain access to the event at the event venue and that enable the second individual to transfer limited use rights to the purchased ticket to a third party.

13. The system of claim 10, further comprising:
receiving instructions from the first individual indicating that the limited use rights to the purchased ticket are to be transferred to a third individual; and
causing an offer of the limited use rights to the purchased ticket to be communicated to the third individual, wherein if the third individual accepts the limited use rights, information in the record of the database of ticket information corresponding to the purchased ticket is updated to reflect that the third individual has limited use rights to the purchased ticket and the second barcode information recorded in the record of the ticket database corresponding to the purchased ticket is replaced with third barcode information, where the third barcode information can be acquired and used by the third individual to cause a barcode to be displayed on a display screen to enable the third individual to gain access to the event at the event venue if the limited use rights to the purchased ticket are not subsequently revoked by the first individual.

14. The system of claim 10, further comprising:
receiving instructions from the first individual indicating that the limited use rights to the purchased ticket previously granted to the second individual are to be revoked;
causing information in the record of the database of ticket information corresponding to the purchased ticket to be updated to reflect that the first individual again has all rights to the purchased ticket; and
causing the second barcode information recorded in the record of the ticket database corresponding to the purchased ticket to be replaced with third barcode information, where the third barcode information can be acquired and used by the first individual to cause a barcode to be displayed on a display screen to enable the first individual to gain access to the event at the event venue.

15. A method of purchasing ticket rights, comprising:
receiving instructions from a first individual regarding the purchase of a ticket for a seat at an event in an event venue;
interacting with a ticket seller or reseller to purchase the ticket identified in the received instructions.

16. The method of claim 15, wherein interacting with the ticket seller or reseller results in a record in a database of ticket information that corresponds to the purchased ticket being updated to reflect that the first individual is the owner of purchased ticket, and wherein interacting with the ticket seller or reseller further results in first barcode information being recorded in the record in the ticket database that corresponds to the purchased ticket, where the first barcode information can be acquired and used by the first individual to cause a barcode to be displayed on a display screen to enable the first individual to gain access to the event at the event venue.

17. The method of claim 16, the method further comprising:
receiving instructions from the first individual indicating that limited use rights to the purchased ticket are to be offered to a second individual, the limited use rights allowing the second individual to access the event at the event venue; and
causing an offer of the limited use rights to the purchased ticket to be communicated to the second individual, wherein if the second individual accepts the limited use rights, information in the record of the database of ticket information corresponding to the purchased ticket is updated to reflect that the second individual has limited use rights to the purchased ticket and the first barcode information recorded in the record of the ticket database corresponding to the purchased ticket is replaced with second barcode information, where the second barcode information can be acquired and used by the second individual to cause a barcode to be displayed on a display screen to enable the second individual to gain access to the event at the event venue if the limited use rights to the purchased ticket are not subsequently revoked by the first individual.

18. The method claim 17, wherein the limited use rights are display-only rights that enable the second individual to acquire and use the second barcode information to cause a barcode to be displayed on a display screen to enable the second individual to gain access to the event at the event venue but which do not enable the second individual to transfer any use rights to the purchased ticket to a third party.

19. The method of claim 17, wherein the limited use rights include display rights that enable the second individual to acquire and use the second barcode information to cause a barcode to be displayed on a display screen to enable the second individual to gain access to the event at the event venue and that enable the second individual to transfer limited use rights to the purchased ticket to a third party.

20. The method of claim 17, wherein the method further comprises:
receiving instructions from the first individual indicating that the limited use rights to the purchased ticket are to be transferred to a third individual; and
causing an offer of the limited use rights to the purchased ticket to be communicated to the third individual, wherein if the third individual accepts the limited use rights, information in the record of the database of ticket information corresponding to the purchased ticket is updated to reflect that the third individual has limited use rights to the purchased ticket and the second barcode information recorded in the record of the ticket database corresponding to the purchased ticket is replaced with third barcode information, where the third barcode information can be acquired and used by the third individual to gain access to the event at the event venue if the limited use rights to the purchased ticket are not subsequently revoked by the first individual.

21. The method of claim 17, wherein the method further comprises:
receiving instructions from the first individual indicating that the limited use rights to the purchased ticket previously granted to the second individual are to be revoked;
causing information in the record of the database of ticket information corresponding to the purchased ticket to be updated to reflect that the first individual again has all rights to the purchased ticket; and
causing the second barcode information recorded in the record of the ticket database corresponding to the purchased ticket to be replaced with third barcode information, where the third barcode information can be acquired and used by the first individual to cause a barcode to be displayed on a display screen to enable the first individual to gain access to the event at the event venue.
